(19) United States
(12) Patent Application Publication
(10) Pub. No.: US 2011/0043955 A1
(43) Pub. Date: Feb. 24, 2011

(54) ELECTROSTATIC DISCHARGE PROTECTION CIRCUIT, CONTROL METHOD THEREFOR, AND SWITCHING REGULATOR USING SAME

(75) Inventor: Ippei Noda, Osaka (JP)

Correspondence Address: COOPER & DUNHAM, LLP, 30 Rockefeller Plaza, 20th Floor, NEW YORK, NY, 10112, US

(73) Assignee: RICOH COMPANY, LTD., Tokyo (JP)

(21) Appl. No.: 12/851,035

(22) Filed: Aug. 5, 2010

(30) Foreign Application Priority Data
Aug. 19, 2009 (JP) 2009-189865

(51) Int. Cl. H02H 9/04

(52) U.S. Cl. 361/56

(57) ABSTRACT

A protection circuit to protect an element against static electricity includes a clamp element connected in parallel to the protected element and a static electricity detection circuit connected to the protected element, to detect static electricity applied to the protected element. The static electricity detection circuit clamps a voltage applied to the protected element by turning on the clamp element when the detected static electricity exceeds a predetermined value and, in response to an externally input enable signal, turns off the clamp element, thereby stopping clamping the voltage applied to the protected element.

### CROSS-REFERENCE TO RELATED APPLICATIONS

This application claims priority from Japanese Patent Application No. 2009-189865, filed on Aug. 19, 2009, the disclosure of which is hereby incorporated by reference herein in its entirety.

### BACKGROUND OF THE INVENTION

1. Field of the Invention

The present invention generally relates to a protection circuit for protecting a switching element against static electricity, a control method therefor, a switching regulator including the same, and a method of protecting the switching regulator against static electricity.

2. Discussion of the Background Art

Laterally diffused metal oxide semiconductor (LDMOS) transistors are widely used as switching elements in switching regulators that output relatively high voltages to enhance efficiency because LDMOS transistors have a relatively high resistance against high pressure and a relatively low on-resistance.

However, high-pressure resistant elements typically have lower self-protection against electrostatic discharge (ESD) and lower resistance against breakdown, and thus it is difficult to protect such high-pressure resistant elements from ESD with a protection element. In particular, such tendency is significant in LDMOS transistors, and the on-resistance of the LDMOS transistor increases as the resistance against ESD is enhanced. That is, there is a trade-off between protection against ESD and on-resistance. Therefore, when LDMOS transistors are used as switching elements in switching regulators, the area of the switching element should be expanded to keep the on-resistance lower while attaining desirable protection against ESD. Accordingly, when the switching regulator is integrated on an integrated circuit (IC), the IC chip becomes larger.

In view of the foregoing, protection circuits against static electricity using an active element are proposed. For example, JP-2004-022950-A discloses a protection circuit against static electricity shown in FIG. 1.

The protection circuit against static electricity shown in FIG. 1 is for protecting an internal circuit 130 and includes diodes D131 and D132, an N-channel metal oxide semiconductor (NMOS) transistor M131, and capacitors C131 and C132.

In FIG. 1, the capacitors C131 and C132 respectively have such capacities that, when no static electricity is applied to an input terminal IN, a gate voltage Vx of the NMOS transistor M131 is satisfactorily lower than a threshold voltage of the NMOS transistor M131.

When static electricity, which causes negative surge voltage or instantaneous high pressure, is applied to the input terminal IN, the diode D132 is turned on and the voltage at a power source terminal T2 decreases sharply. Then, although the source voltage of the NMOS transistor M131 also decreases significantly, the voltage between the gate and source (gate-source voltage) of the NMOS transistor M131 exceeds the threshold voltage because decreases in its gate voltage are smaller than decreases in its source voltage. As a result, the NMOS transistor M131 is turned on. Accordingly, a surge of electrical current caused by the static electricity flows to the NMOS transistor M131 and then is consumed therein. With this configuration, increases in a power source voltage of the internal circuit 130 can be restricted reliably, thus protecting the internal circuit 130 from the surge voltage.

FIG. 2 illustrates circuitry of a step-up switching regulator including a switching transistor and an active protection circuit, such as shown in FIG. 1, for protecting the switching transistor from static electricity. In FIG. 2, reference characters 110, 120, M101, and M102 represent the step-up switching regulator, a static electricity detection circuit, the switching transistor, and a clamp element, respectively. The step-up switching regulator 110 further includes a feedback circuit 111, a pulse-width modulation (PWM) circuit 112, a drive circuit 113, an external load 150, a diode D101, and an inductor L101.

The switching transistor M101 used in the step-up switching regulator 110 is an N-channel LDMOS transistor and is to be protected from static electricity. The static electricity detection circuit 120 and the clamp element M102 that is an NMOS transistor together form an electrostatic discharge protection circuit for protecting the switching transistor M101 against static electricity.

When the switching regulator 110 is not active, a voltage VLX at a junction node LX between the inductor L101 and the switching transistor M101 is substantially identical to an input voltage Vin. In such a state, the voltage at both ends of a capacitor C121 is identical or similar to the voltage VLX, and the input terminal of an inverter circuit 121 is turned low. As a result, the output terminal of another inverter circuit 122 is turned low, and thus the clamp element M102 is turned off.

When static electricity is applied to the switching regulator 110 and accordingly the voltage between the source and the drain (source-drain voltage) of the switching transistor M101 increases sharply, electrical current flows through the capacitor C121 to a resistor R121. Consequently, the voltage at both ends of the resistor R121 drops, which increases the input voltage of the inverter circuit 121.

In the inverter circuit 121, when the input voltage exceeds a threshold voltage Vth, the level of an output signal output therefrom is inverted to low. As the inverter circuit 122 inverts the level of that output signal again, the gate voltage of the clamp element M102 turns high, and thus the clamp element M102 is turned on. Then, because the static electricity applied to the switching transistor M101 is consumed by the clamp element M102, the voltage VLX decreases. Thus, the voltage VLX can be prevented from increasing significantly. In the configuration shown in FIG. 2, because the clamp element M102 is turned on when the voltage VLX at the junction node LX increases sharply above the threshold voltage Vth, the voltage applied to the switching transistor M101 is clamped at the sum of the input voltage Vin and the threshold voltage Vth of the inverter circuit 121.

FIG. 3 is a timing chart illustrating the waveform of the voltage VLX at the junction node LX and on/off states of the switching transistor M101 and the clamp element M102 when the step-up switching regulator 110 is activated.

In FIG. 3, a waveform indicated by broken lines represents operation of the switching transistor M101 when the switching regulator 110 operates normally.

Although the switching transistor M101 can be protected from static electricity, adding the protection circuit against static electricity to the switching regulator 110 adversely affects the switching transistor M101, that is, the switching transistor M101 does not perform the normal operation shown in FIG. 3, which is described in further detail below.

When the switching regulator 110 starts operating, the switching transistor M101 is turned off at a time t1 and the voltage VLX at the junction node LX increases sharply with the energy stored in the inductor L101. When the voltage VLX thus increases, electrical current is supplied through the capacitor C121 to the resistor R121 as described above, and then the voltage of the resistor R121 drops. When the voltage of the resistor R121 is reduced below the threshold voltage Vth of the inverter circuit 121, the clamp element M102 is turned on, and then the increase in the voltage VLX is stopped. Although the voltage VLX can increase to about 23 V normally, the increase in the voltage VLX stops at about 9 V or 10 V in this configuration as shown in FIG. 3. Consequently, on/off timing of the switching transistor M101 is shifted significantly because an output voltage Vo cannot rise to a proper voltage, thus hindering the step-up switching regulator 110 from operating normally.

In view of the foregoing, the inventor of the present invention recognizes that there is a need for switching regulators to operate normally even when an electrostatic discharge protection circuit is provided for the switching transistor.

### SUMMARY OF THE INVENTION

An illustrative embodiment of the present invention provides a protection circuit for protecting an element against static electricity by clamping static electricity applied to that element. The protection circuit includes a clamp element connected in parallel to the protected element and a static electricity detection circuit to detect the static electricity applied to the protected element. When the detected static electricity exceeds a predetermined value, the static electricity detection circuit clamps a voltage applied to the protected element by turning on the clamp element. The static electricity detection circuit turns off the clamp element and stops operating in response to an externally input enable signal.

Another illustrative embodiment of the present invention provides a method of controlling the above-described protection circuit against static electricity. The control method includes a step of detecting static electricity applied to the protected element when an externally input enable signal causes the protection circuit to start operating, a step of clamping voltage applied to the protected element by turning on the clamp element when the detected static electricity exceeds a predetermined value, and a step of turning off the clamp element and turning off the protection circuit when the enable signal causes the protection circuit to stop operating.

Yet another illustrative embodiment of the present invention provides a switching regulator that starts operating in response to an externally input enable signal, converts an input voltage input to an input terminal to a predetermined voltage, and outputs the predetermined voltage as an output voltage from an output terminal. The switching regulator includes a switching transistor that performs switching according to a control signal input to a control electrode thereof, an inductor to be charged with the input voltage by the switching of the switching transistor, a rectification element to discharge the inductor when charging of the inductor by the switching transistor is stopped, a control circuit that operates in response to an enable signal and controls the switching of the switching transistor so that the output voltage is kept at the predetermined voltage, and the above-described protection circuit for protecting the switching transistor from static electricity.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates circuitry of a related-art electrostatic discharge protection circuit;

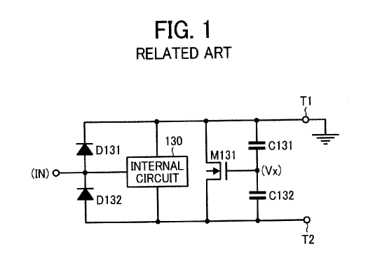

FIG. 2 illustrates circuitry of a step-up switching regulator using a related-art electrostatic discharge protection circuit;

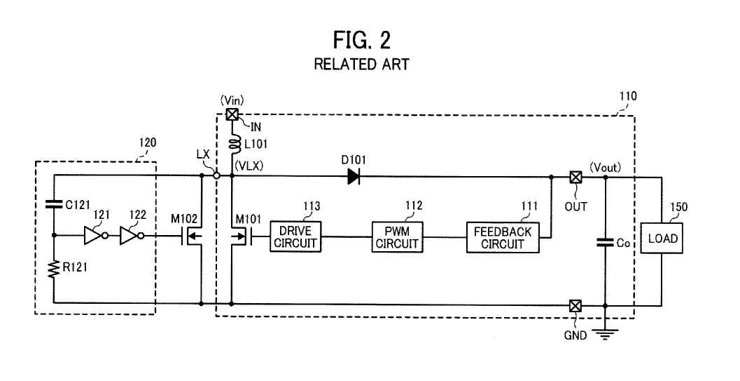

FIG. 3 is a timing chart illustrating operations of the step-up switching regulator shown in FIG. 2;

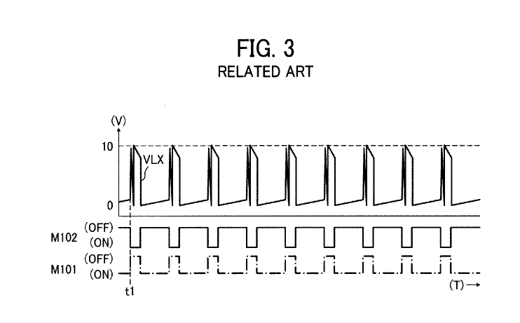

FIG. 4 illustrates circuitry of a direct current to direct current (DC-DC) converter in which an electrostatic discharge protection circuit according to an illustrative embodiment of the present invention is used for a step-up switching regulator; and

FIG. 5 is a timing chart illustrating operations of the DC-DC converter shown in FIG. 4.

### DETAILED DESCRIPTION OF PREFERRED EMBODIMENTS

In describing example embodiments illustrated in the drawings, specific terminology is employed for the sake of clarity. However, the disclosure of this patent specification is not intended to be limited to the specific terminology so selected, and it is therefore to be understood that each specific element includes all technical equivalents that operate in a similar manner.

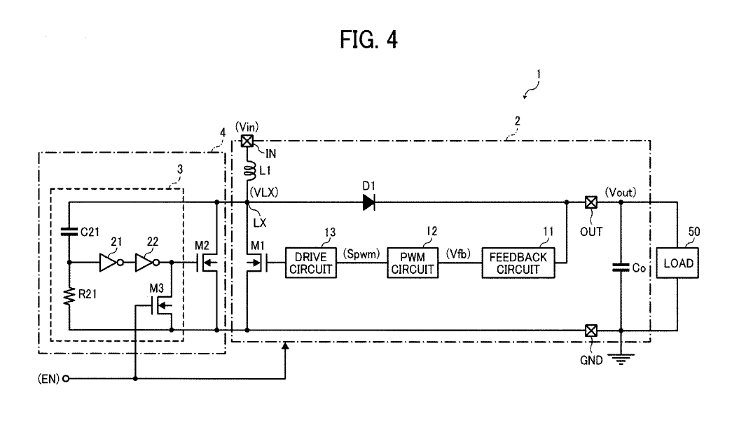

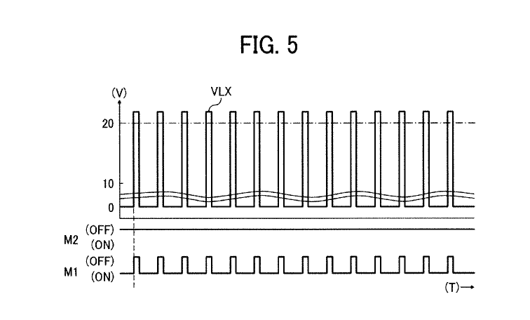

Referring now to the drawings, wherein like reference numerals designate identical or corresponding parts throughout the several views, and particularly to FIGS. 4 and 5, an electrostatic discharge (ESD) protection circuit according to an illustrative embodiment of the present invention is described below.

FIG. 4 illustrates circuitry of a DC-DC converter including a step-up switching regulator provided with an ESD protection circuit according to an illustrative embodiment of the present invention.

In FIG. 4, a DC-DC converter 1 serves as an asynchronous-rectification type step-up switching regulator that steps up an input voltage Vin input to an input terminal IN to a predetermined or desirable voltage and outputs an output voltage Vout from an output terminal OUT to an external load 50.

The DC-DC converter 1 includes a switching regulator 2 and an ESD protection circuit 4. The switching regulator 2 steps up the input voltage Vin to the predetermined or desirable voltage and outputs it as the output voltage Vout from the output terminal OUT. The ESD protection circuit 4 includes a clamp element M2 that is an NMOS transistor and a static electricity detection circuit 3. The switching regulator 2 further includes a switching transistor M1 that is an N-channel LDMOS transistor, a rectification diode D1, an inductor L1, an output capacitor Co, a feedback circuit 11, a PWM circuit 12, and a drive circuit 13. The feedback circuit 11 generates and outputs a feedback voltage Vfb proportional to the output voltage Vout. The PWM circuit 12 performs pulse width modulation of the feedback voltage Vfb and generates a pulse signal Spwm. The drive circuit 13 controls on/off switching of the switching transistor M1 according to the pulse signal Spwm.

The static electricity detection circuit 3 includes an NMOS transistor M3, inverter circuits 21 and 22, a capacitor C21, and a resistor R21.

It is to be noted that the rectification diode D1 serves as a rectification element, and the feedback circuit 11, the PWM circuit 12, and the drive circuit 13 together form a control circuit. Additionally, the respective circuits in the DC-DC converter 1 except the output capacitor Co may be integrated on an integrated circuit (IC). In this case, the input terminal IN, the output terminal OUT, and the ground terminal GND respectively serve as connection terminals, and the IC may further includes another input terminal to which an enable signal EN is input.

The inductor L1 and the switching transistor M1 are connected serially between the input terminal IN and the ground terminal GND connected to the ground voltage, and the junction node between the inductor L1 and the switching transistor M1 is hereinafter referred to as “junction node LX”. The anode of the rectification diode D1 is connected to the junction node LX, and the cathode thereof is connected to the output terminal OUT. The feedback circuit 11 receives the output voltage Vout and outputs the feedback voltage Vfb to the PWM circuit 12. Further, the pulse signal Spwm generated by the PWM circuit 12 is input to the drive circuit 13, and the output terminal of the drive circuit 13 is connected to the gate of the switching transistor M1.

The clamp element M2 is connected in parallel to the switching transistor M1, and the NMOS transistor M3 is connected between the gate of the clamp element M2 and the ground terminal GND. To the gate of the NMOS transistor M3, the enable signal EN is input externally. Additionally, the capacitor C21 and the resistor R21 are connected serially between the junction node LX and the ground terminal GND, and the junction node between the capacitor C21 and the resistor R21 is connected to the input terminal of an inverter circuit 21. The output terminal of the inverter circuit 21 is connected to an input terminal of another inverter circuit 22 whose output terminal is connected to the gate of the clamp element M2. Although connection therebetween is not illustrated in detail, the enable signal EN is input to the switching regulator 2 as well, and thus the switching regulator 2 is activated or stopped in response to the enable signal EN. For example, the control circuit including the feedback circuit 11, the PWM circuit 12, and the drive circuit 13 is activated or stopped in response to the enable signal EN.

In the switching regulator 2 configured as described above, when the output voltage Vout increases, the pulse width of the pulse signal Spwm output by the PWM circuit 12 is varied so that the period during which the switching transistor M1 is on becomes shorter. Accordingly, the output voltage Vout decreases. By contrast, when the output voltage Vout decreases, in the switching regulator 2, the pulse width of the pulse signal Spwm output by the PWM circuit 12 is varied so that the period during which the switching transistor M1 is on becomes longer. Accordingly, the output voltage Vout increases. The switching regulator 2 keeps the output voltage Vout constant at the predetermined voltage by repeating these operations.

When the switching regulator 2 is not active, the voltage VLX at the junction node is substantially identical to the input voltage Vin. In such a state, the voltage at both ends of the capacitor C21 is identical or similar to the voltage VLX, and the input terminal of the inverter circuit 21 is turned low. As a result, the output terminal of the inverter circuit 22 is turned low, and the clamp element M2 is turned off (isolated).

Protection against static electricity when the switching regulator 2 is not active is described below.

When static electricity is applied to the switching regulator 2 and the source-drain voltage of the switching transistor M1 increases sharply, electrical current flows through the capacitor C21 to the resistor R21. Consequently, the voltage at both ends of the resistor R21 drops, which increases the input voltage of the inverter circuit 21.

In the inverter circuit 21, when the input voltage exceeds a threshold voltage Vth, the level of an output signal output from its output terminal is inverted to low. As the inverter circuit 22 inverts the level of that output signal again, the gate voltage of the clamp element M2 turn high, and thus the clamp element M2 is turned on. Then, because the static electricity applied to the clamp element M2 is consumed by the clamp element M2, the voltage VLX decreases. Thus, the voltage VLX can be prevented from increasing significantly. In the configuration shown in FIG. 4, because the clamp element M2 is turned on when the voltage VLX increases sharply and exceeds the threshold voltage Vth, the voltage applied to the switching transistor M1 is clamped at the sum of the input voltage Vin and the threshold voltage Vth of the inverter circuit 21.

As described above, when the switching regulator 2 is not active, the ESD protection circuit 4 including the static electricity detection circuit 3 and the clamp element M2 is activated, and thus the switching transistor M1 can be prevented from receiving high voltage.

Herein, the enable signal EN is for controlling operation of the switching regulator 2. The switching regulator 2 starts operating when the enable signal EN is high and is stopped when the enable signal EN is low.

When the enable signal EN is low, the NMOS transistor M3 is turned off, and, in this state, operation of the clamp element M2 is controlled as described above.

When the enable signal EN turns high, the switching regulator 2 starts operating, and the NMOS transistor M3 is turned on simultaneously, thus causing a short circuit between the gate and the source of the clamp element M2. Therefore, the clamp element M2 is turned off and does not affect the operation of the switching regulator 2.

FIG. 5 is a timing chart illustrating a waveform of the voltage VLX and on/off states of the switching transistor M1 and the clamp element M2 when the switching regulator 2 shown in FIG. 4 is active.

In FIG. 5, when the switching transistor M1 is turned off, simultaneously, the voltage VLX increases sharply with the energy stored in the inductor L1. Then, electrical current flows to the resistor R21 through the capacitor C21, thereby reducing the voltage of the resistor R21. When the voltage of the resistor R21 becomes lower than the threshold voltage Vth of the inverter circuit 21, the level of the output signal from the inverter circuit 21 is inverted to low. However, because the NMOS transistor M3 keeps the level of the output terminal of the inverter circuit 22 low, the gate of the clamp element M2 does not rise to high and accordingly the clamp element M2 remains off.

To keep the clamp element M2 off, the switching transistor M1 controls the voltage VLX. Further, the switching transistor M1 is controlled by the feedback circuit 11, the PWM circuit 12, and the drive circuit 13. As it can be known from FIG. 5, for example, the voltage VLX may rise to about 23 V, which is required to output the rated output voltage Vout, and the switching regulator 2 repeats normal voltage step-up operations because the clamp element M2 does not affect the switching regulator 2.

Next, descriptions are given below of operation of the DC-DC converter 1 shown in FIG. 4 when static electricity is applied to the switching regulator 2 that is active.

When static electricity is applied to the switching regulator 2 in which the switching transistor M1 is on, the static electricity is consumed by the switching transistor M1 and does not have adverse effects.

By contrast, when static electricity is applied to the switching regulator 2 in which the switching transistor M1 is off, the static electricity is consumed by the output capacitor Co and the load 50 both connected to the output terminal OUT via the diode D1. Because the capacity of the output capacitor Co is generally much greater than the amount of the static electricity applied thereto, the voltage VLX increases only slightly, and thus the switching transistor M1 does not get broken.

Thus, when the switching regulator 2 is active, the static electricity can be consumed by the switching transistor M1, the output capacitor Co, and the load 50 even when the clamp element M2 is off. Therefore, the switching transistor M1 does not get broken.

As described above, the present embodiment provides an ESD protection circuit that protects an element, for example, a switching transistor in a switching regulator, against static electricity by clamping the static electricity applied to that element. The ESD protection circuit includes a clamp element connected in parallel to the protected element and a static electricity detection circuit to detect the static electricity. When the static electricity exceeds a predetermined value, the static electricity detection circuit clamps a voltage applied to the protected element by turning on the clamp element. The static electricity detection circuit stops operating in response to an externally input enable signal, thereby turning off the clamp element.

The static electricity detection circuit detects the voltage applied to both ends of the protected element, and the clamp element is constructed of a MOS transistor.

The present embodiment provides a method of controlling the above-described ESD protection circuit. The control method includes a step of detecting static electricity when an externally input enable signal indicates that the ESD protection circuit should start operating, a step of clamping a voltage applied to the protected element by turning on the clamp element when the static electricity exceeds a predetermined value, and a step of turning off the clamp element to turn off the ESD protection circuit when the enable signal indicates that the protection circuit should stop operating.

The present embodiment provides a switching regulator that starts operating in response to an externally input enable signal, converts an input voltage input to an input terminal to a predetermined voltage, and outputs the predetermined voltage as an output voltage from an output terminal. The switching regulator includes a switching transistor that performs switching according to a control signal input to a control electrode thereof, an inductor to be charged with the input voltage by the switching of the switching transistor, a rectification element to discharge the inductor when charging of the inductor by the switching transistor is stopped, a control circuit to control the switching of the switching transistor so that the output voltage is kept at the predetermined voltage according to the enable signal, and the above-described ESD protection circuit.

Additionally, the present embodiment provides a method of protecting the above-described switching regulator against static electricity. The method includes a step of detecting static electricity applied to the switching transistor when the externally input enable signal causes the switching regulator to stop operating, a step of clamping of the voltage applied to the switching transistor by turning on the clamp element when the detected static electricity exceeds a predetermined value, and a step of turning off the clamp element on order to stop clamping of the voltage applied to the switching transistor when the enable signal causes the switching transistor to start operating.

In the ESD protection circuit, the control method thereof, the switching regulator using the ESD protection circuit, and the method of protecting the switching regulator against the static electricity according to the present embodiment, when the amount of the detected static electricity exceeds a predetermined value, the clamp element is turned on, thereby clamping the voltage applied to the protected element, for example, a switching transistor in the case of the switching regulator. The ESD protection circuit is kept from operating while the switching regulator operates according to the enable signal. That is, the clamp element is turned off in response to an externally input enable signal, which stops clamping the voltage applied to the protected element. Accordingly, an active-type ESD protection circuit can be used for protecting the switching transistor.

Therefore, an LDMOS transistor, which has higher resistance against high pressure, a lower on-resistance, and a relatively small element size, can be used as the switching transistor. Accordingly, the increase in the size of the IC tip can be limited while enhancing the efficiency of the switching regulator.

Additionally, the source-drain voltage of the switching transistor is restricted with the clamp element that is switched between on and off in response to the enable signal, and the clamp element is turned off compulsively when the switching regulator operates according to the enable signal, thus eliminating the need for additional control signals. Therefore, the ESD protection circuit is kept from operating with a simple circuit.

It is to be noted that, although the description above concerns a configuration using an asynchronous-rectification type step-up switching regulator, the present invention is not limited thereto. Alternatively, the present invention may be applied to step-down switching regulators, step-down and step-up switching regulators, or synchronous rectification switching regulators.

Numerous additional modifications and variations are possible in light of the above teachings. It is therefore to be understood that, within the scope of the appended claims, the disclosure of this patent specification may be practiced otherwise than as specifically described herein.

What is claimed is:

1. A protection circuit to protect an element against static electricity,
the protection circuit comprising:
a clamp element connected in parallel to the protected element; and
a static electricity detection circuit connected to the protected element, to detect static electricity applied to the protected element,
the static electricity detection circuit clamping a voltage applied to the protected element by turning on the clamp element when the detected static electricity exceeds a predetermined value,
the static electricity detection circuit stopping operating and turning off the clamp element in response to an externally input enable signal.

2. The protection circuit according to claim 1, wherein the static electricity detection circuit detects voltage applied to both ends of the protected element.

3. The protection circuit according to claim 1, wherein the clamp element is constructed of a MOS transistor.

4. The protection circuit according to claim 1, wherein the protected element is a switching transistor included in a switching regulator.

5. A method of controlling a protection circuit for protecting an element against static electricity,
the protection circuit comprising a clamp element connected in parallel to the protected element and a static electricity detection circuit,
the method comprising:
detecting static electricity when an externally input enable signal indicates start of the protection circuit;
clamping a voltage applied to the protected element by turning on the clamp element when the detected static electricity exceeds a predetermined value; and
turning off the clamp element when the externally input enable signal indicates operation stop of the protection circuit.

6. The method according to claim 5, wherein the step of detecting static electricity comprises detecting voltage applied to both ends of the protected element.

7. A switching regulator that starts operating in response to an externally input enable signal, converts an input voltage input to an input terminal to a predetermined voltage, and outputs the predetermined voltage as an output voltage from an output terminal,
the switching regulator comprising:
a switching transistor that performs switching according to a control signal input to a control electrode thereof;
an inductor to be charged with the input voltage by the switching of the switching transistor;
a rectification element to discharge the inductor when charging of the inductor by the switching transistor is stopped;
a control circuit to keep the output voltage at the predetermined voltage by controlling the switching of the switching transistor; and
a protection circuit to protect the switching transistor against static electricity,
the protection circuit including,
a clamp element connected in parallel to the switching transistor, and
a static electricity detection circuit to detect static electricity applied to the switching transistor,
the static electricity detection circuit clamping a voltage applied to the switching transistor by turning on the clamp element when the detected static electricity exceeds a predetermined value,
the static electricity detection circuit stopping operating and turning off the clamp element in response to the externally input enable signal.

8. The switching transistor according to claim 7, wherein the static electricity detection circuit detects voltage applied to both ends of the switching transistor.

9. The switching transistor according to claim 7, wherein the clamp element is constructed of with a MOS transistor.

10. The switching transistor according to claim 7, wherein the switching transistor is an LDMOS transistor.
